(19) United States
(12) Patent Application Publication
(10) Pub. No.: US 2012/0097499 A1
(43) Pub. Date: Apr. 26, 2012

(54) ROTARY TRANSPORT SYSTEM AND CONTROLLING METHOD THEREOF

(75) Inventors: HUAN-CHENG LIN, TAIPEI COUNTY (TW); TSAN-I CHEN, TAOYUAN COUNTY (TW)

(73) Assignee: INOTERA MEMORIES, INC., Taoyuan County (TW)

(21) Appl. No.: 12/963,839

(22) Filed: Dec. 9, 2010

(30) Foreign Application Priority Data
Oct. 20, 2010 (TW) 99135786

(51) Int. Cl. B65G 43/00; B65G 37/00

(52) U.S. Cl. 198/341.01; 198/347.2

(57) ABSTRACT

A rotary transport system has a main track with transport(s) or shuttle(s) moving along the main track and an auxiliary storage unit. The auxiliary storage unit has a plurality of storing positions, and the storing positions are rotating around the main track. Therefore, the object, such as a FOUP (Front Opening Unified Pod) can be loaded on or unloaded from the storing positions.

### BACKGROUND OF THE INVENTION

1. Field of the Invention

The instant disclosure relates to a rotary transport system and a controlling method thereof; in particular, a rotary transport system and a controlling method thereof for semiconductor manufacturing facilities.

2. Description of Related Art

In a semiconductor fabrication plant, production materials are often stored at different manufacturing bays waiting to be processed, or kept at the same manufacturing bay on multiple occasions for undergoing a particular fabrication step. Modern semiconductor fabrication plants typically employ automated transport systems for more precise and efficient handling of the production materials. The main objective is to assist in moving the production materials to the manufacturing bay, or for moving the treated production materials or end products from the manufacturing bay to a specific storage location. Particularly, transport systems may be used for moving the production materials stored at different storage locations or in between stations.

The conventional overhead material handling system, such as OHT (Overhead Hoist Transport) and OHS (Overhead Shuttle), usually relies on a ceiling rail arranged above the floor of the working area to move transport carriages (carriers). Typically, storage cells are set up along the rail path to stock production materials or end products. However, as production capacity expands, the conventional storage cells are unable to meet the demand for additional storage spaces. For example, the number of conventional storage cell is restricted by the length of the rail. Thus, to increase the storage capacity, the only option is to expand the plant, which would incur extra cost.

### SUMMARY OF THE INVENTION

The object of the instant disclosure is to provide a rotary transport system and controlling method thereof. By using the space near the track or in between the production machines, the load can be temporary stored by the rotary transport system, thus enhancing the storage capacity. Furthermore, the transporting efficiency is improved.

The rotary transport system of the instant disclosure comprises a main track, a plurality of shuttle carriages traversing on the main track, and an auxiliary storage unit near the main track. The auxiliary storage unit has a plurality of storage stations (i.e., storing platforms). The storage stations are rotatably disposed with respect to the main track. Thereby, the shuttle traversing on the main track can unload or pick up the load from one of the storage stations rotated to underneath the track.

The controlling method of the rotary transport system comprises the steps of:

Step 1: Providing a main track and a plurality of shuttle carriages, where the shuttle carriages traverse on the main track;

Step 2: Providing an auxiliary storage unit near the main track, where the auxiliary storage unit has a plurality of storing platforms respectively defining a storing position thereon, and the storing platforms are rotatably disposed with respect to the main track;

Step 3: Providing a transport signal; and

Step 4: Implementing a transport step; Based on the transport signal, one of the shuttle carriages transport a load to one of the storing positions, or conversely, one of the shuttle carriages takes on a load being stored at one of the storing positions.

The instant disclosure mainly offers a rotary transport system having a rotatably device disposed near the main track to increase the storage capacity by utilizing the unused space in the product-manufacturing plant and further increase the load/unload efficiency of the transport system. In addition, the rotary transport system of the instant disclosure communicates directly with the shuttle carriages on the main track to implement the transport process, thus increasing the transport efficiency.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIGS. 1A to 1I show the transport process of the first embodiment of the instant disclosure.

FIGS. 2A to 2E show the transport process of the second embodiment of the instant disclosure.

FIG. 3 shows a schematic view of a concentric turntable of the third embodiment of the instant disclosure.

FIGS. 3A to 3E show the transport process of the third embodiment of the instant disclosure.

### DETAILED DESCRIPTION OF THE PREFERRED EMBODIMENTS

The instant disclosure provides a rotary transport system and controlling method thereof for load/unload object. The instant disclosure set forth more storage space in the confined factory layout to store additional materials such as raw materials, end products, and so forth. In addition, the transport system's efficiency is increased also.

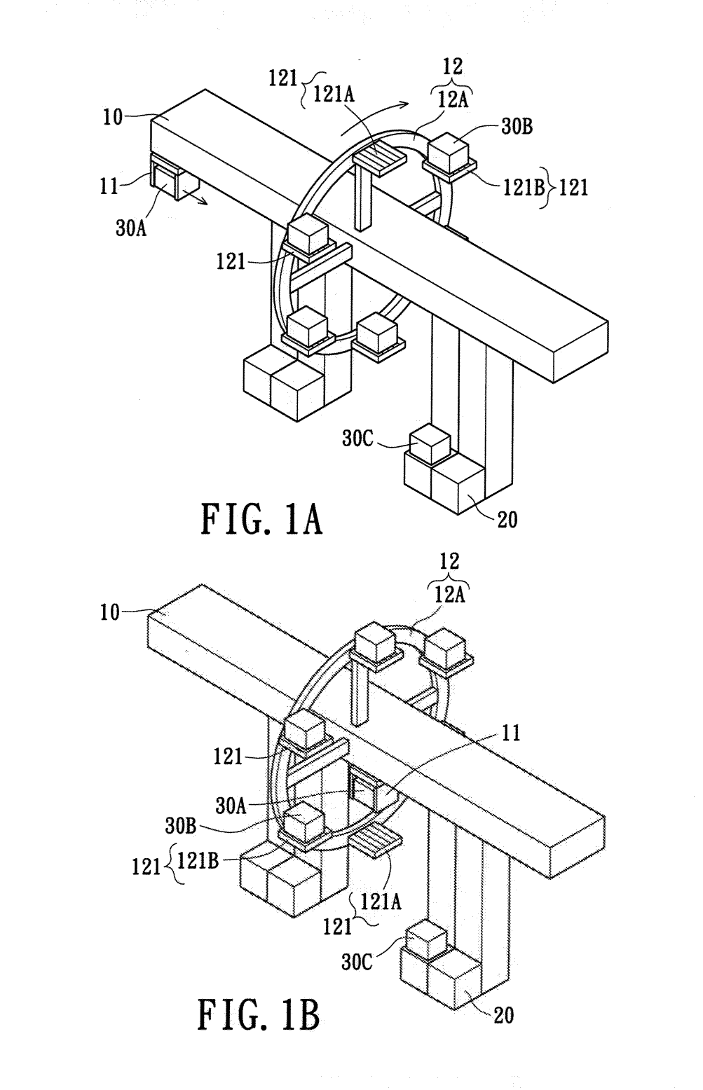

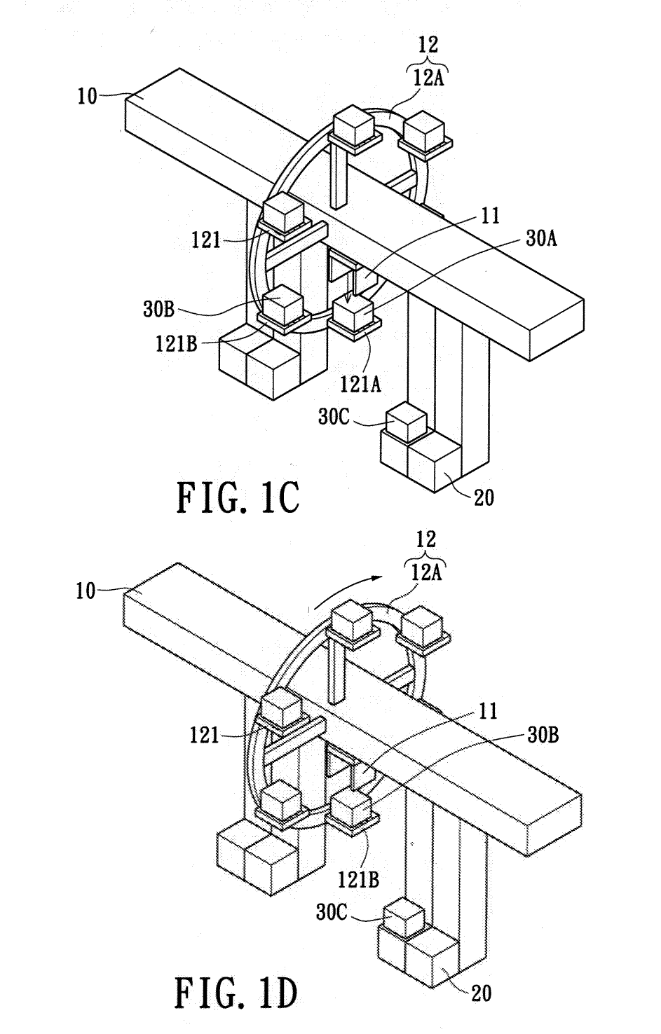

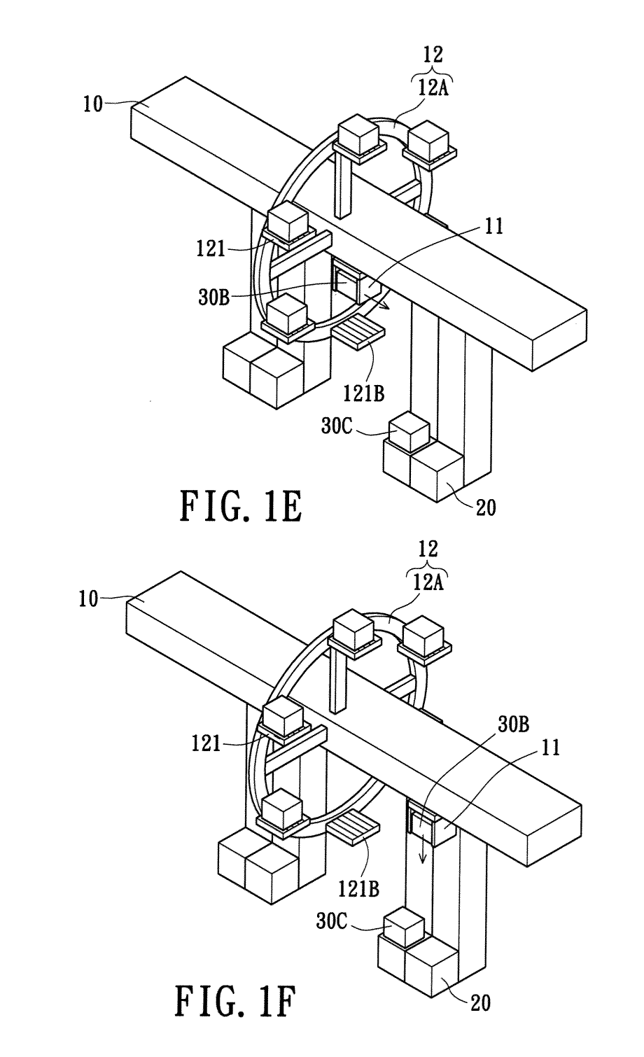

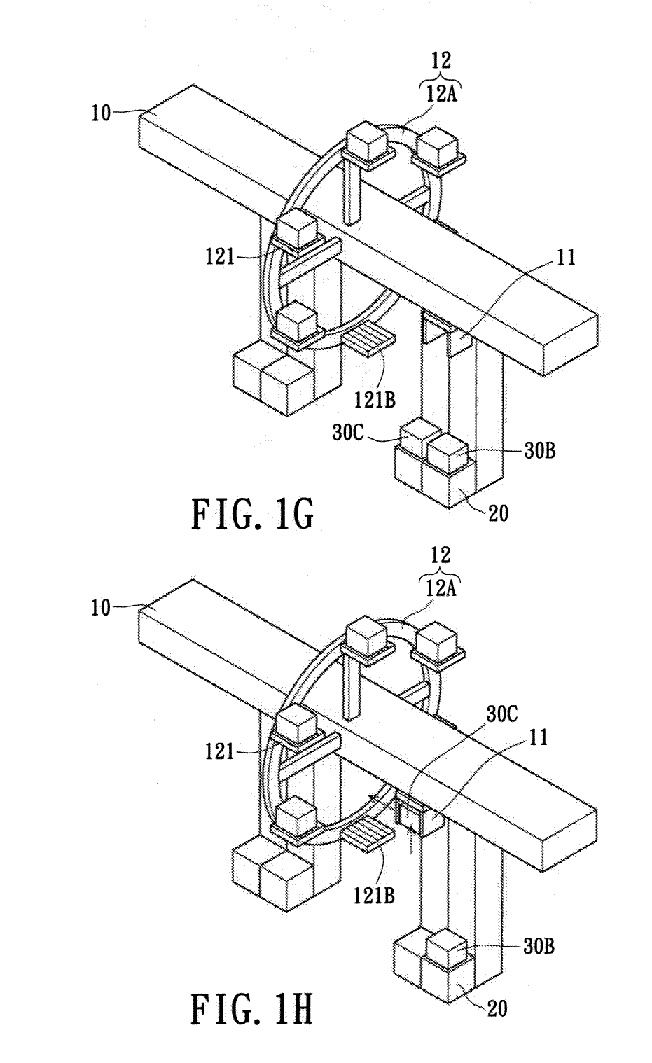

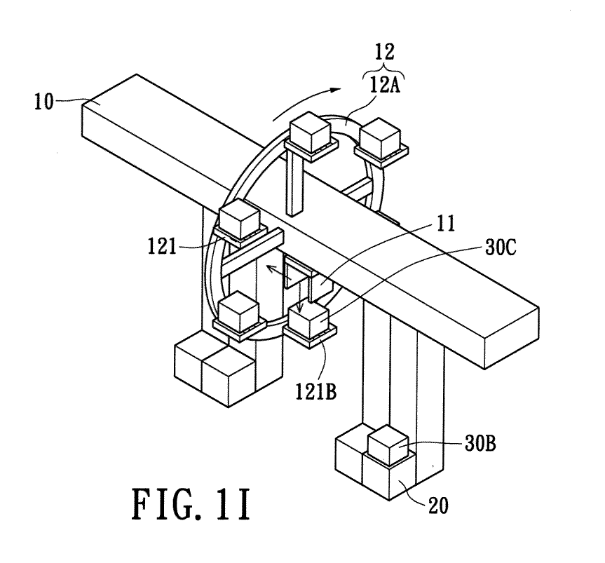

The instant disclosure utilizes the unused space in between the production machines or above the machine itself for storage space. Please refer to FIG. 1A, where the rotary transport system of the instant disclosure comprises a main track 10, a shuttle carriage 11 (i.e., shuttle) traversing on the main track 10, and an auxiliary storage unit 12 arranged near the main track 10. In the exemplary embodiment, the main track 10 is an Overhead Shuttle (OHS) material handling system, but is not restricted to. The shuttle 11 can be a vehicle, a platform, or the like, that traverses on the ceiling rail of the plant to transport the load such as FOUP (Front Opening Unified Pod). The load 30A, 30B, and 30C can represent any raw materials, material supplies, end products, FOUP, and the like.

Furthermore, the auxiliary storage unit 12 has a plurality of storing positions 121 which are defined by the storing platforms. The storing platforms with the storing positions 121 are disposed rotatably with respect to the main track 10. In other words, the storing positions 121 of the auxiliary storage unit 12 can revolve around the main track 10, to dispose a particular storing position 121 underneath the main track 10 after receiving the system command. Thereby, the shuttle 11 running on the main track 10 can unload or reload on or from the storing position 121 under the main track 10.

Please refer to FIGS. 1A thru 1I, which show the first embodiment of the instant disclosure, where the rotary transport system of the instant disclosure includes the vertical auxiliary storage unit 12. As shown in the figures, the vertical auxiliary storage unit 12 has a vertical rail 12A, where a plurality of storing platforms is disposed on the vertical rail 12A. The vertical rail 12A is ring shaped, where the storing platforms traverse on the vertical rail 12A and circle around the main track 10 sequentially. The rotational direction can be unidirectional or bidirectional. The storing platforms can respectively have a platform structure or any other configurations or storing position for temporary storing objects or for transporting objects. In other words, the storing platforms can be configured to the storing positions 121 for storing the stock. Specifically, each storing platform forms the storing position 121 for carrying the stock rotatably around the main track 10 or the stock can be temporary stored in the storing positions 121.

The controlling method for the first embodiment of the instant disclosure comprises the following steps.

First, the main track 10 and the shuttle 11 are provided. Also, a control system including CPU, memory unit, interface, and so on is used to record the position and quantity of the shuttle carriages 11 into a database. In the exemplary embodiment, the control system can have multiple control solutions for managing transport signals, rotation path, storage availability, database, and the like.

Next, the auxiliary storage unit 12 is provided, where the control system also includes information regarding the position and load information of the storing positions 121 of the auxiliary storage unit 12.

When load transport is needed, the control system issues a transport signal to achieve the transporting, loading, or unloading process.

The next step involves the transporting sequence. Namely, one of the shuttle carriages 11 transport the load to one of the storing platforms per transport signal. Conversely, the transport signal can request one of the shuttle carriages 11 to receive the load from the storing positions 121 of one selected storing platform and transport to a specified location, such as a production machine.

As shown in FIGS. 1A thru 1C, which show the shuttle 11 is commanded to transport the load 30A to an empty storing position 121A (the control system can identity the storing position via the database). Namely, the shuttle 11 traverses along the main track 10 to transport the load 30A. Simultaneously, a selected storing platform with empty storing positions 121 also traverse on the vertical rail 12A. The traversing motion stops when the shuttle 11 and the storing position 121A have reached the loading zone (As shown in FIG. 1B, the storing position 121A is underneath the main track 10). In turn, the shuttle 11 can release and store the load 30A onto the storing position 121A. Basically, the storing platforms rotate sequentially around the main track 10, where an empty storing position 121A of one storing platform is rotated to be under the main track 10 per transport signal. Then, one of the shuttle carriages 11 is ordered by the transport signal to release the load onto the empty storing position 121A of the storing platform.

Please also refer to FIGS. 1D thru 1G, which show the shuttle 11 is ordered by the transport signal to transport the load 30B from the storing position 121B to the production machine 20. Notably, FIG. 1C shows the relative positions of the storing positions 121A and 121B. In FIG. 1C, the storing position 121B has already passed the loading zone (underneath the main track 10). Thereby, after receiving the transport signal from the control system, the storing position 121B traverses on the vertical rail 12A until reaching underneath the main track 10. Conversely, the storing position 121B can be ordered to rotate backwards to be under the main track 10. In other words, the control system can option for the most efficient way to control the rotating direction of the storing positions 121. When the storing position 121B arrives the loading zone (underneath the main track 10), the shuttle 11 can pick up and transport the load 30B to the production machine 20 (as shown in FIG. 1G). Namely, the storing platforms rotate around the main track 10 sequentially, where the storing platform having the load 30B ordered by the control system is rotated to be underneath the main track 10. One of the shuttle carriages 11 is ordered to pick up the load 30B from the storing position 121B.

Please also refer to FIGS. 1G to 1I, which show the shuttle 11 is ordered to transport the load 30C from the production machine 20 to the storing position 121B. Notably, because the shuttle 11 has already passed the loading zone, when the shuttle 11 receives the order from the control system, the shuttle 11 can traverse backwards in returning to the loading zone. Alternatively, another shuttle 11 can be ordered to carry out the same request.

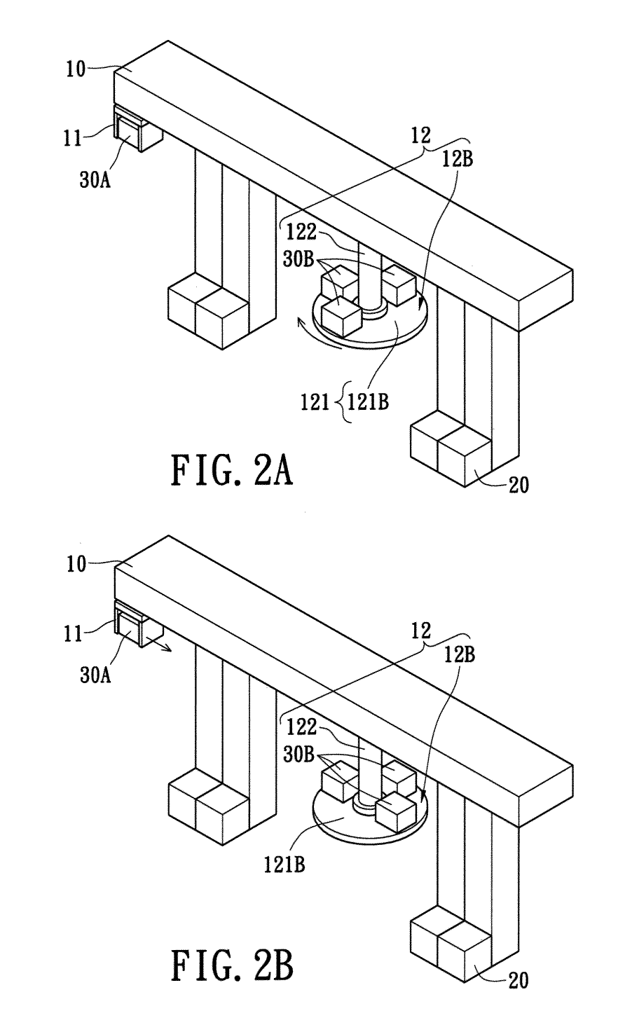

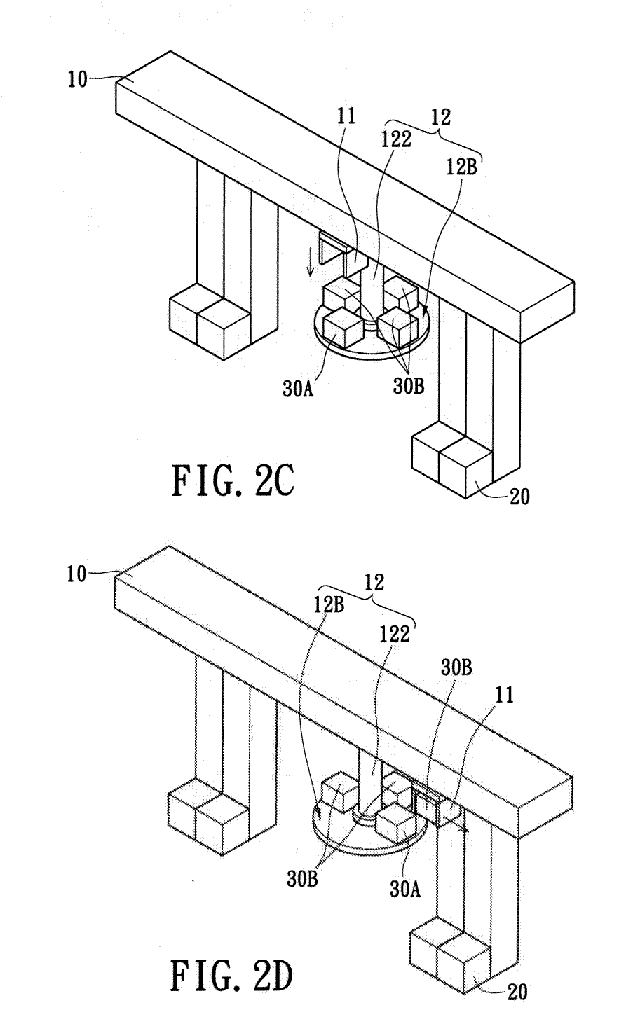

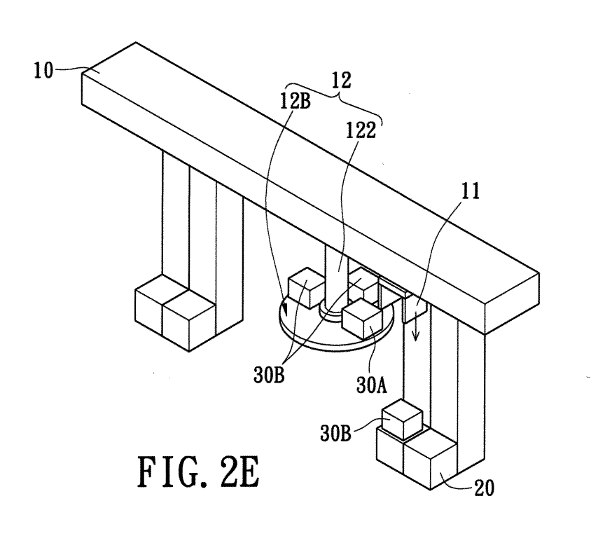

Please refer to FIG. 2A, which shows the second embodiment of the instant disclosure. The difference between the first and second embodiments is with the auxiliary storage unit 12. Namely, the auxiliary storage unit 12 of the second embodiment has a horizontal storage structure, which includes a shaft 122 and a turntable 12B attached thereof. The storing positions 121 are disposed on the turntable 12B. As shown in FIG. 2A, the shaft 122 can be connected to the main track 10, and four storing positions 121 are formed on the turntable 12B. Three of the storing positions 121 already have the load 30B, and only one empty storing position 121, or 121B, is left.

Therefore, in the abovementioned scenario, when the control system issues a transport command, the turntable 12B is rotated by the shaft 122 for turning the empty storing position 121B to the loading zone (as shown in FIG. 2B, the storing position 121B is underneath the main track 10). Meanwhile, the shuttle 11 traverses on the main track 10 in transporting the load 30A. When the shuttle 11 and the storing position 121B arrive at the loading zone, the shuttle 11 releases the load 30A onto the storing position 121B (as in FIG. 2C). In other words, during the transport process, the turntable 12 rotates sequentially, where the empty storing position (i.e. 121B) is ordered to be rotated to underneath the main track 10. Thus, one of the shuttle carriages 11 ordered by the control system is able to release the load 30A onto the empty storing position (i.e. 121B).

Please also refer to FIGS. 2D and 2E, which show the shuttle 11 is ordered to transport the load 30B from the storing position 121 to the production machine 20. In the exemplary embodiment, the turntable 12B turns continuously by the rotating shaft 122, thus moving the ordered load 30B to the loading zone. Then, the shuttle 11 can transport the load 30B to the production machine 20. In other words, during the transport stage, the turntable 12B rotates sequentially in moving the storing position 121 having the ordered load (i.e. 30B) to be underneath the main track 10. One of the shuttle carriages 11 is ordered to pick up the load 30B from the storing position 121. Notably, the turntable 12B can rotate positively (clockwise) or negatively (counter clockwise), to be efficient in transporting and storing the load.

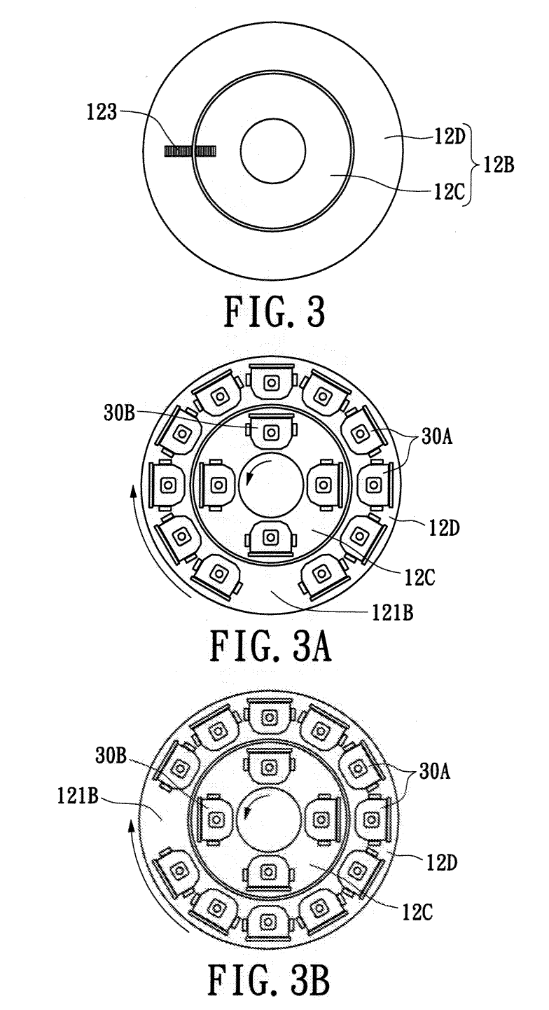

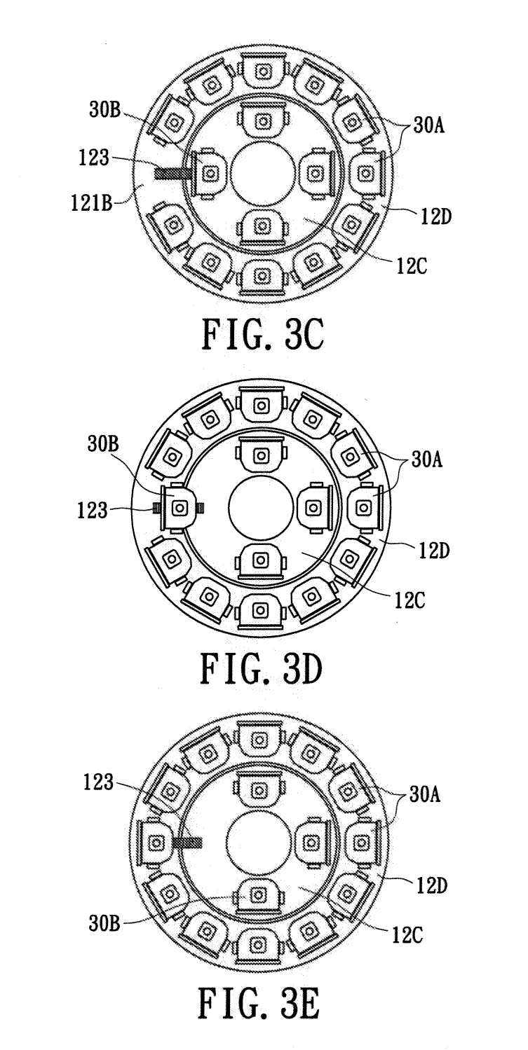

Please refer to FIG. 3, which shows the third embodiment of the instant disclosure. The third embodiment is a variation of the second embodiment. The turntable 12B is divided into a concentric first turntable 12C and a second turntable 12D. The first turntable 12C is concentrically encircled by the second turntable 12D. The load 30A and 30B can be disposed on both the first and second turntables 12C and 12D. Furthermore, a transport rail 123, such as a conveyor, rollers, and the like, is disposed in between the first and second turntables 12C and 12D. Thereby, the load can be transported between the first and second turntables 12C and 12D via the transport rail 123. Specifically, FIGS. 3A thru 3E show the transport process of the load 30B from the first turntable 12C to the second turntable 12D. First, the first turntable 12C and the second turntable 12D rotate in opposite direction respectively, where the load 30B on the first turntable 12C and the empty storing position 121B on the second turntable 12D are rotated to the loading zone (i.e. on the transport rail 123, as shown in FIG. 3B). Next, the load 30B on the first turntable 12C can be transported onto the second turntable 12D via the transport rail 123. In other words, the transport rail 123 can be used to transport the load between different turntables, in achieving efficient transport and storage capabilities.

Furthermore, the turntable 12B of the instant disclosure can comprise a plurality of auxiliary turntables (as abovementioned first and second turntables 12C and 12D). Via the use of transport rail (i.e. transport rail 123) between different auxiliary turntables, the storage space of the rotary transport system can be increased significantly.

In summary, based on the abovementioned material handling structures and controlling method of different embodiments, the instant disclosure provides additional storage space in between the tracks, thus enhancing the storage capacity of the plant. The stocked items of the storage space can be loaded on or off the shuttle, thus enhancing the efficiency of space utilization of the plant.

Based on the above discussions, the instant disclosure has the following advantages. First, the rotary transport system of the instant disclosure is located in between or above the production machines. The location is unusable by the present material handling systems such as OHT or OHS. The number of the rotary transport system is not restricted by the length of the track, thereby providing greater storage capacity versus conventional design. Secondly, the rotary transport system of the instant disclosure can be installed away from underneath the track of the OHT, thereby not interfering with resolving abnormal situations and regular maintenance of the shuttle of the OHT and switching in/out of the production machines. In other words, the instant disclosure would not interfere with the current shuttle system.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A rotary transport system applied for semiconductor manufacturing, comprising:
a main track elevated from the floor for transporting a plurality of shuttle carriages; and
an auxiliary storage unit arranged near the main track comprising a plurality of storing platforms respectively defining a storing position thereon, wherein one of the shuttle carriages accesses payloads from and to the storing position on one of the storing platforms under the main track.

2. The rotary transport system of claim 1, wherein the storing platforms are vertically arranged.

3. The rotary transport system of claim 2, wherein the auxiliary storage unit has a vertical rail around the main track, the storing platforms traversing on the vertical rail, wherein the storing platforms rotate sequentially around the main track.

4. The rotary transport system of claim 1, wherein the storing platforms are horizontally arranged.

5. The rotary transport system of claim 4, wherein the auxiliary storage unit has a shaft and a rotatable turntable disposed on the shaft, and wherein the storing platforms are disposed on the turntable.

6. The rotary transport system of claim 5, wherein the turntable further comprises a plurality of concentric auxiliary turntables, and wherein a transport rail is disposed in between different auxiliary turntables.

7. The rotary transport system of claim 5, wherein the turntable further comprises a concentric first turntable and a second turntable, wherein the first turntable is encircled concentrically by the second turntable, and wherein a transport rail is disposed in between the first and second turntables.

8. A controlling method of the rotary transport system applied to semiconductor manufacturing, comprising the steps of:
providing a main track elevated from the floor having a plurality of shuttle carriages traversing along the main track;
providing an auxiliary storage unit arranged near the main track, wherein the auxiliary storage unit has a plurality of storing platforms respectively defining a storing position thereon, and wherein the storing platforms are disposed rotatably and relatively to the main track;
providing a transport signal; and
implementing a transport process, wherein one of the shuttle carriages is ordered by the transport signal to transport an object to the storing position of one of the storing platforms, or one of the shuttle carriages is ordered by the transport signal to pick up an object from the storing position of one of the storing platforms.

9. The controlling method of the rotary transport system of claim 8, wherein the auxiliary storage unit comprises a vertical rail around the main track, the storing platforms traversing on the vertical rail, wherein in the step of implementing a transport process, the storing platforms rotate sequentially around the main track for moving one of the storing platforms having the object ordered by the transport signal to be underneath the main track, wherein one of the shuttle carriages ordered by the transport signal picks up the object from the storing position of said one of the storing platforms; or, in the step of implementing a transport process, the storing platforms rotate sequentially around the main track for moving one of the storing platforms having the empty storing position ordered by the transport signal to be underneath the main track, wherein one of the shuttle carriages ordered by the transport signal loads the object onto the empty storing position of said one of the storing platforms.

10. The controlling method of the rotary transport system of claim 8, wherein the auxiliary storage unit comprises a shaft and a rotatable turntable disposed rotatably on the shaft, wherein in the step of implementing a transport process, the turntable rotates sequentially for moving one of the storing platforms having the object ordered by the transport signal to be underneath the main track, wherein one of the shuttle carriages ordered by the transport signal picks up the object from the storing position of said one of the storing platforms; or, in the step of implementing a transport process, the turntable rotates sequentially for moving one of the storing platforms having the empty storing position ordered by the transport signal to be underneath the main track, wherein one of the shuttle carriages ordered by the transport signal loads the object onto the empty storing position of said one of the storing platforms.

11. The controlling method of the rotary transport system of claim 10, wherein the turntable further comprises a plurality of concentric auxiliary turntables, wherein a transport rail is disposed in between different auxiliary turntables, and wherein the transport step further includes transporting the objects between different auxiliary turntables by the transport rails.

12. The controlling method of the rotary transport system of claim 10, wherein the turntable further comprises a concentric first turntable and a second turntable, the first turntable is encircled concentrically by the second turntable, wherein a transport rail is disposed in between the first turntable and the second turntable, and wherein the transport step further includes the step of transporting objects between the first turntable and the second turntable by the transport rail.
